(19) United States
(12) Patent Application Publication
(10) Pub. No.: US 2024/0391032 A1
(43) Pub. Date: Nov. 28, 2024

(54) METHOD OF RESISTANCE SPOT WELDING

(71) Applicant: TOYOTA JIDOSHA KABUSHIKI KAISHA, Toyota-shi (JP)

(72) Inventors: Shota EJIMA, Nagoya-shi (JP); Tomoko OGASAHARA, Nagoya-shi (JP); Tomohiko SEKIGUCHI, Nagakute-shi (JP); Toru HIOKI, Nisshin-shi (JP); Nao KAWABE, Chiba-shi (JP); Takaya OBARA, Toyota-shi (JP)

(73) Assignee: TOYOTA JIDOSHA KABUSHIKI KAISHA, Toyota-shi (JP)

(21) Appl. No.: 18/663,242

(22) Filed: May 14, 2024

(30) Foreign Application Priority Data
May 26, 2023 (JP) 2023-086612

(51) Int. Cl. B23K 31/00; B23K 11/11; B23K 11/36

(52) U.S. Cl. CPC B23K 31/006; B23K 11/115; B23K 11/36

(57) ABSTRACT

A method of resistance spot welding comprises: preparing a machine learning model having learned a relation between a feature of a test data and a quality of a welding state of a test welding, the test data recording a time series change in an expansion amount of a workpiece in the test welding; and determining the quality of the welding state of a main welding using a main welding data and the machine learning model, the main welding data recording a time series change in an expansion amount of the workpiece in the main welding. The feature includes a first feature and a second feature, the first feature being with respect to a gradient of a change in an expansion amount of the workpiece during an expansion period in which the workpiece expands by energization, the second feature being with respect to a gradient of a change in an expansion amount of the workpiece during a contraction period in which the workpiece contracts after the expansion period.

### CROSS-REFERENCE TO RELATED APPLICATIONS

The present application claims priority from Japanese patent application P2023-86612 filed on May 26, 2023, the disclosure of which is hereby incorporated in its entirety by reference into the present application.

### BACKGROUND

### Field

The present disclosure relates to resistance spot welding methods.

### Related Art

For example, JP 2001-300738 discloses measuring degree of thermal expansion of the workpiece during energization, and degree of contraction of the workpiece at the end of welding, then determining whether or not an appropriate nugget is formed in the workpiece based on these degrees.

As in JP 2001-300738, by utilizing the expansion amount of the workpiece during resistance spot welding, it is possible to determine the quality of the welding. It is desired to further improve the accuracy of such quality determination.

### SUMMARY

The present disclosure may be implemented as the following aspects.

According to one aspect of the present disclosure, a method of resistance spot welding is provided. The method comprises: preparing a machine learning model having learned a relation between a feature of a test data and a quality of a welding state of a test welding, the test data recording a time series change of an expansion amount of a workpiece in the test welding; and determining the quality of the welding state of a main welding using a main welding data and the machine learning model, the main welding data recording a time series change of an expansion amount of the workpiece in the main welding. The feature includes a first feature and a second feature, the first feature being with respect to a gradient of a change of an expansion amount of the workpiece during an expansion period in which the workpiece expands by energization, the second feature being with respect to a gradient of a change of an expansion amount of the workpiece during a contraction period in which the workpiece contracts after the expansion period.

### BRIEF DESCRIPTION OF THE DRAWINGS

FIG. 1 is a diagram showing a schematic configuration of a resistance spot welding apparatus;

FIG. 2 is an explanatory view of a test data;

FIG. 3 is an explanatory diagram showing an example of the type of disturbance;

FIG. 4 is an explanatory view showing an example of the estimation result of the nugget diameter;

FIG. 5 is a process diagram of a resistance spot welding method;

FIG. 6 is a flowchart of a generation process.

### DETAILED DESCRIPTION

### A. First Embodiment

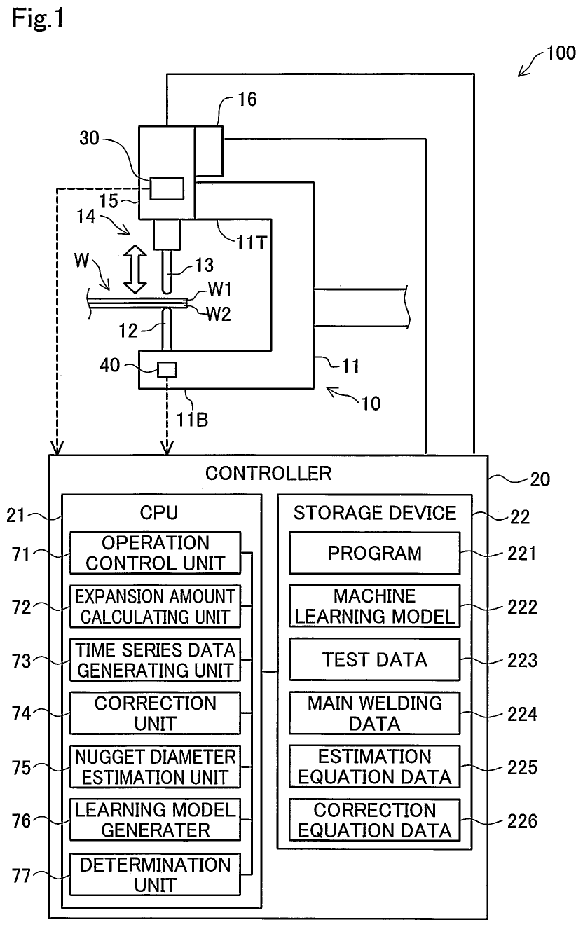

FIG. 1 is a diagram showing a schematic configuration of a resistance spot welding apparatus 100. Resistance spot welding apparatus 100 joins by melting the workpiece W in which a plurality of metal plates is superimposed. Specifically, the workpiece W has a first metal plate W1 and the second metal plate W2 superimposed on each other.

The resistance spot welding apparatus 100 includes a welding gun 10, a resistance measuring device 16, and a controller 20. Welding gun 10 includes a gun body 11, the lower electrode 12 and the upper electrode 13 is a pair of electrodes, and an electrode lifting device 14. The gun body 11 has an upper arm 11T, and a lower arm 11B. The lower electrode 12 is fixed to the lower arm 11B. The upper electrode 13 is fixed to the upper arm 11T via the electrode lifting device 14. The electrode lifting device 14 is configured as an electric lifting device having a servo motor 15. The electrode lifting device 14 holds the upper electrode 13. The electrode lifting device 14 raises and lowers the upper electrode 13 by a rotational driving force of the servo motor 15. That is, the upper electrode 13 is movable by the electrode lifting device 14 in a direction along a direction in which the upper electrode 13 and lower electrode 12 face each other.

When welding the workpiece W, while pressurizing across the workpiece W by the upper electrode 13 and the lower electrode 12, the resistance spot welding apparatus 100 supplies a welding current through both electrodes to the workpiece W. In this way, the workpiece W is melted by Joule heat due to energization. Thereafter, the workpiece W is cooled and solidified, the first metal plate W1 and the second metal plate W2 are joined. The workpiece W expands with melting by energization and contracts with cooling after the energization is completed. A nugget is formed at a bonding interface of the welded plurality of metal plates.

The resistance measuring device 16 measures an electrical resistance value between the lower electrode 12 and the upper electrode 13. The measured electrical resistance value is transmitted to the controller 20.

The resistance spot welding apparatus 100 further comprises an encoder 30 and a strain gauge 40. The encoder 30 detects a rotation amount of the servo motor 15 at each predetermined time, and transmits a signal indicating the detected rotation amount to the controller 20. The strain gauge 40 detects an amount of displacement of the lower electrode 12 due to an external force every predetermined time, and transmits a signal indicating the amount of displacement to the controller 20. The encoder 30 and the strain gauge 40 are used to detect a distance between the upper electrode 13 and the lower electrode 12.

The controller 20 is composed of a computer including a CPU 21 and a storage device 22. The storage device 22 stores a program 221, a machine learning model 222, test data 223, main welding data 224, estimation equation data 225, and correction equation data 226. The program 221 is for controlling the operation of the resistance spot welding apparatus 100. CPU 21 executes the program 221 stored in the storage device 22 to realize various functions, such as a function as the operation control unit 71, the expansion amount calculating unit 72, the time series data generating unit 73, the correction unit 74, the nugget diameter estimation unit 75, the learning model generator 76 and the determination unit 77. The controller 20 may be constituted by a circuit.

The Operation control unit 71 controls the operation of the resistance spot welding apparatus 100.

The expansion amount calculating unit 72 calculates an expansion amount of the workpiece W by calculating the distance between the upper electrode 13 and the lower electrode 12 at each predetermined time using a detected value of the strain gauge 40 and a detected value of the encoder 30. In the present specification, the expansion amount is an amount of change in distance between the upper electrode 13 and the lower electrode 12 from the state in which the workpiece W is sandwiched by the upper electrode 13 and the lower electrode 12 before the welding current is flowed through the workpiece W. The expansion amount is correlated with the size of the nugget. The size of the nugget such as a nugget diameter, which is the diameter of the nugget, is used as an indicator of the quality of the welding state. Therefore, it is possible to determine the quality of the welding state based on the expansion amount.

The time series data generating unit 73 generates time series data based on the expansion amount calculated by the expansion amount calculating unit 72. The time series data records a time series change in the expansion amount of the workpiece W. Specifically, the time series data generating unit 73 generates a test data 223 and a main welding data 224 as the time series data. The main welding data 224 is data obtained by recording the time series change in the expansion amount in the main welding. The main welding is for actually manufacturing a product. Test data 223 is data obtained by recording time series change in the expansion amount in the test welding. The test welding is performed prior to the main welding.

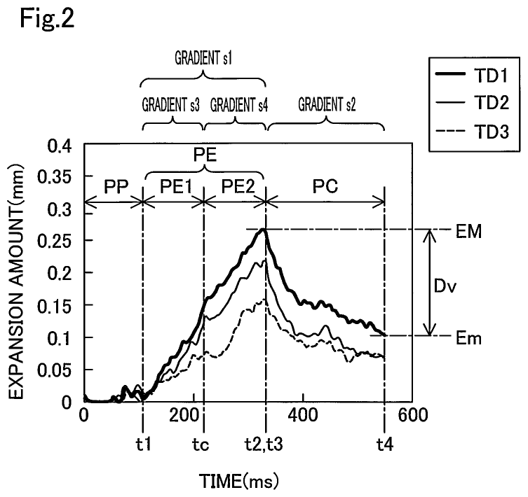

FIG. 2 is an explanatory view of a test data 223. Specifically, FIG. 2 is a graph in which the horizontal axis and the elapsed time, the vertical axis and the expansion amount of the workpiece W. In FIG. 2, test data TD1, test data TD2, and test data TD3 are shown as examples of test data 223. The test data TD1 is data related to test welding in which the welding state is good and does not include disturbances to be described later. Test data TD2 are data on test welds that have good welding states and include disturbances. More particularly, the test data TD2 is data related to test welds including “gaps” which will be described later as disturbances. The test data TD3 is data on test welding in which the welding state is defective. Although not shown, the main welding data 224 is recorded as substantially the same data as the test data 223 shown in FIG.

The test data TD1, TD2, and TD3 are each associated with a label relating to the outcome of the test welding for each test data 223. The test data TD1 is associated with a first label. The first label represents the test weld with good welding state and no disturbance. A second label is associated with the test data TD2. The second label shows the type of the disturbance in the test welding in which the welding state is good and the disturbance is included. For example, the second label associated with the test data TD2 represents a “gap” as a type of disturbance. A third label is associated with the test data TD3. The third label is a label representing a test welding in which the welding state is defective.

In the present embodiment, when the test welding includes multiple types of disturbances, the test data 223 of the test welding is associated with a second label representing the type of disturbance that is more dominant in the test welding. In other embodiments, when the test welding includes multiple types of disturbances, test data 223 for the test welding may be associated with a second label representing, for example, that the test welding includes each type of disturbance.

As shown in FIG. 2, in the test data 223, time series changes in the expansion amount are recorded at least from an expansion period PE to a contraction period PC. The expansion period PE means a period during which the workpiece W is expanded by energization. Specifically, in the expansion period PE, while being pressurized by the upper electrode 13 and the lower electrode 12, the workpiece W expands by energization through the upper electrode 13 and the lower electrode 12. The contraction period PC is a period after the expansion period PE. The contraction period means a period during which the workpiece W is contracted. Specifically, in the contraction period PC, the workpiece W cools and contracts by being pressurized by the upper electrode 13 and the lower electrode 12 with energization stopped. The test data shown in FIG. 2 further includes time series changes in the expansion in the preload period PP. In the preload period PP, while being not energized, the workpiece W is pressurized by the upper electrode 13 and the lower electrode 12.

The learning model generator 76 generates the machine learning model 222 by executing machine learning using the feature of the test data 223. The machine learning model 222 is a learning model having learned a relation between the feature of the test data 223 and the quality of the welding state of the test welding. As the machine learning model 222, for example, various machine learning models such as a random forest, a support vector machine (SVM), a neural network, or the like may be used. Details of a method of generating the machine learning model 222 in the present embodiment will be described later.

The feature of the test data 223 used for generating the machine learning model 222 includes a first feature and a second feature. The first feature is a feature relating to a gradient of the change of the expansion amount in the expansion period PE shown in FIG. 2. The second feature is a feature relating to a gradient of the change of the expansion amount in the contraction period PC. Furthermore, the first feature in the present embodiment includes a third feature and a fourth feature. The third feature is a feature relating to a gradient of the change of the expansion amount in the first period PE1. The fourth feature is a feature relating to a gradient of the change of the expansion quantity in the second period PE2. the second period PE2 is a period after the first period PE1. Specifically, the first period PE1 in the present embodiment is a period from an expansion start timing t1 to a current value change timing tc. The expansion start timing t1 is a timing at which the expansion period PE is started. The current value change timing tc represents a timing at which the magnitude of the weld current is changed in the expansion period PE. The second period PE2 is a period from the current value changing timing tc to an expansion end timing t2. The expansion end timing t2 is a timing at which the expansion period PE ends. In the present embodiment, the welding current supplied to the workpiece W in the second period PE2 is greater than the welding current supplied to the workpiece W in the first period PE1. The expansion start timing t1 can also be said to be a timing at which the preload period PP ends. The expansion end timing t2 can also be said to be a contraction start timing t3. The contraction start timing t3 is a timing at which the contraction period PC is started.

In FIG. 2, various features of the test data TD1 are shown as exemplary features of the test data 223. Specifically, FIG. 2 shows, as features of the test data TD1, a gradient s1, a gradient s2, a gradient s3, a gradient s4, a maximum expansion amount value EM, a minimum expansion amount value Em, and a difference value Dv.

The gradient s1 represents the gradient of the change in the expansion amount from the expansion start timing t1 to the expansion end timing t2. Specifically, the gradient s1 is calculated as a value obtained by dividing a difference between the expansion amount in the expansion start timing t1 and the expansion amount in the expansion end timing t2 by the elapsed time between the two timings. The gradient s2 represents the gradient of the change in the expansion amount from the contraction start timing t3 to the contraction end timing t4 at which the contraction period PC ends. Specifically, the gradient s2 is calculated as a value obtained by dividing a difference between the expansion amount in the contraction start timing t3 and the expansion amount in the contraction end timing t4 by the elapsed time between the two timings. The gradient s3 represents the gradient of the change in expansion amount from the expansion start timing t1 to the current value change timing tc. Specifically, the gradient s3 is calculated as a value obtained by dividing a difference between the expansion amount in the expansion start timing t1 and the expansion amount in the current value changing timing tc by the elapsed time between the two timings. The gradient s4 represents the gradient of the change in expansion amount from the current value change timing tc to the expansion end timing t2. Specifically, the gradient s4 is calculated as a value obtained by dividing a difference between the expansion amount in the current value changing timing tc and the expansion amount in the expansion end timing t2 by the elapsed time between the two timings. The maximum expansion amount value EM represents the maximum value of the expansion amount in the expansion period PE. The minimum expansion amount value Em represents the minimum value of the expansion amount in the contraction period PC. The difference value Dv represents a difference between the maximum expansion amount value EM and the minimum expansion amount value Em. In other words, the difference value represents the amount of change in the expansion amount in the contraction period PC.

Of the various features of the test data TD1 shown in FIG. 2, the gradient s1 and the gradient s3 and the gradient s4, respectively, corresponds to the first feature. The gradient s2 corresponds to the second feature. The gradient s3 corresponds to the third feature. The gradient s4 corresponds to the fourth feature. In other embodiments, as long as the first feature is a feature relating to the gradient of the change in the expansion amount in the expansion period PE, may not be a value representing the gradient itself of the change in the expansion amount. For example, the first feature may be a value for calculating a gradient of a change in the expansion amount in the expansion period PE. The second feature, the third feature, and the fourth feature may be in a substantially same manner as the first feature.

The machine learning model 222 in the present embodiment has already learned the relation between the feature of the test data 223 and the type of the disturbance in the test welding.

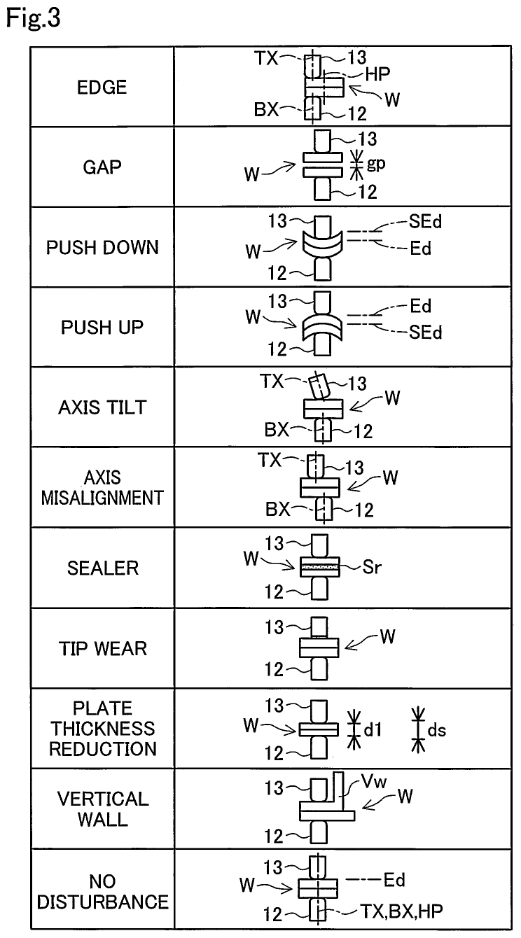

FIG. 3 is an explanatory diagram showing an example of the type of disturbance. In FIG. 3, “Edge”, “Gap”, “Push down”, “Push up”, “Axis tilt”, “Axis misalignment”, “Sealer”, “Tip wear”, “Plate thickness reduction” and “Vertical wall” are shown as examples of types of disturbance. Each disturbance shown in FIG. 3, as will be described later, in the resistance spot welding including the disturbance, as compared with the case in spot welding without disturbance, it acts to reduce the expansion amount relative to the measured value of the nugget diameter.

“Edge” means that the central axis TX of the upper electrode 13 and the central axis BX of the lower electrode 12 are shifted from the desired position HP to the edge side of the workpiece W in the horizontal direction by a reference distance or more. “Gap” means that the size of the gap gp at the beginning of welding between the metallic plates to be welded is equal to or greater than a reference degree. “Push down” means that the position Ed of the upper end of the workpiece W at the beginning of welding is shifted downward from a reference position SEd by a reference degree or more. “Push up” means that the position Ed at the beginning of weld is shifted upward from the reference position SEd by a reference degree or more. “Axis tilt” means that the central axis TX and the central axis BX is tilted from an angle perpendicular to the plate surface of the workpiece W by a standard degree or more. “Axial misalignment” means that a horizontal deviation between the position of the central axis TX and the position of the central axis BX is a reference degree or more. “Sealer” means that welding is performed with an electrically conductive anti-corrosion agent (sealer) Sr applied to the part to be welded to the workpiece W. “Tip wear” means that at least one of the tip portion of the upper electrode 13 and the tip portion of the lower electrode 12 is worn by a reference degree or more. “Plate thickness reduction” means that a thickness d1 of the workpiece W used for welding is smaller than a predetermined standard plate thickness ds by a reference degree or more. “Vertical wall” means that the welding is carried out in the vicinity of the vertical wall Vw in the workpiece W with the vertical wall Vw. The vertical wall Vw means that the part of the workpiece W erected so as to intersect the plate surface of the workpiece W. “No disturbance” shown in FIG. 3 means a welding that does not include any of the above disturbances.

The machine learning model 222 in the present embodiment has learned the relation between the feature of the test data 223 and the “edge” and the “gap”.

The determination unit 77 shown in FIG. 1 determines the quality of the welding state of the main welding using the main welding data 224 and the machine learning model 222. The details of the quality determination to determine the quality of the welding state of the main welding will be described later.

The nugget diameter estimation unit 75 estimates the nugget diameter formed when the resistance spot welding apparatus 100 welds the workpiece W. In the present embodiment, the nugget diameter estimation unit 75 estimates the nugget diameter using the estimation equation represented by the following Equation (1). This estimation equation is included in the estimation equation data 225.

$$ϕ = C 1 \times E + C 2 \times S + C 3 \times R + C 4 \qquad Equation ( 1 )$$

ϕrepresents an estimate of nugget diameter [mm]. E represents the expansion amount [mm] in the expansion period PE. Specifically, in the present embodiment, as the expansion amount E, the integral of the expansion amount from the expansion start timing t1 to the expansion end timing t2 is used. S represents the contraction quantity [mm] in the contraction period PC. Specifically, in the present embodiment, as the contraction amount S, a difference between the contraction amount in the contraction end timing t4 and the expansion amount in the contraction start timing t3 is used. Therefore, the contraction amount S takes a negative value. R represents the electrical resistance value [Ω]. Specifically, in the present embodiment, as the electric resistance value R, the electric resistance value in the second period PE2 is used. C1, C2, C3 and C4 represent constants, respectively. The above estimation equation is defined, for example, using the multiple regression method based on at least one of experimental results of resistance spot welding without disturbance and simulation results of resistance spot welding without disturbance.

The present inventors found that, when the test welding or the main welding includes a disturbance such as the disturbances shown in FIG. 3, as compared with the case where the test welding or the main welding does not include disturbances, a correspondence between the expansion amount and a measured value regarding the size of the nugget (e.g., the measured value of the nugget diameter) is changed. Specifically, when the test welding or the main welding includes each of the disturbances shown in FIG. 3, as compared with the case where the test welding or the main welding does not include the disturbance, the expansion amount is relatively small with respect to the measured value of the nugget diameter. Therefore, when determining the quality of the welding state based on the expansion amount in the main welding including the disturbance, if determining the quality of the welding state as well as the case not including the disturbance, there is a case where the determination accuracy of the quality of the welding state is lowered.

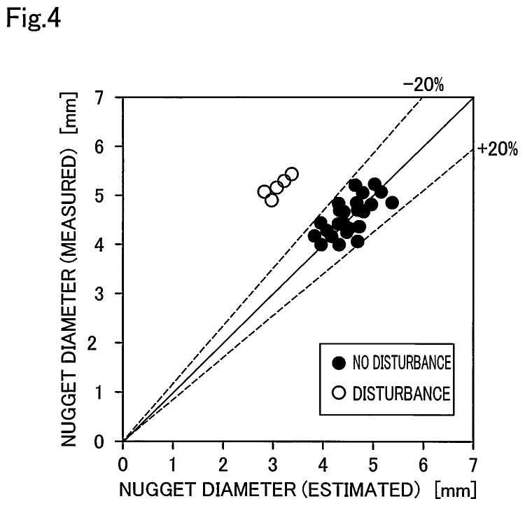

FIG. 4 is an explanatory diagram illustrating an example of an estimation result of the nugget diameter. Specifically, FIG. 4 is a graph in which the horizontal axis is an estimated value of the nugget diameter and the vertical axis is an actual measured value of the nugget diameter. The estimated nugget diameter in FIG. 4 represents the nugget diameter calculated using the above-described Equation (1). In FIG. 4, the results of welding without disturbances (no disturbance) are indicated by black markers and the results of welding with disturbances (disturbance) are indicated by white markers. As shown in FIG. 4, in welding including disturbance, the estimated value of nugget diameter is relatively small relative to the measured value of nugget diameter in comparison with the welding without disturbance. This is because in the welding including the disturbance, as described above, the expansion amount becomes relatively small with respect to the actual nugget diameter.

Correction unit 74 shown in FIG. 1 corrects the main welding data 224 relating to the main welding in accordance with the type of the disturbance included in the main welding when the disturbance is included in the main welding. Specifically, the correction unit 74 corrects the main welding data 224 by the correction equation included in the correction equation data 226. Each correction equation included in the correction equation data 226 is defined for each type of disturbances. The correction equation for a certain type of disturbance is defined as a correction equation for removing influence of the disturbance from the main welding data 224 including the disturbance. For example, a correction equation for a certain type of disturbance is defined as a correction equation for correcting the expansion amount in the test data 223 relating to test welding including the disturbance to the expansion amount equivalent to the expansion amount in the test data 223 relating to test welding including no disturbance based on the results of at least one of experiments and simulations. In the case of estimating the nugget diameter of the main welding including the disturbance, the nugget diameter estimation unit 75 described above, as the expansion amount E, using the integrated value of the expansion amount based on the main welding data 224 corrected by the correction unit 74.

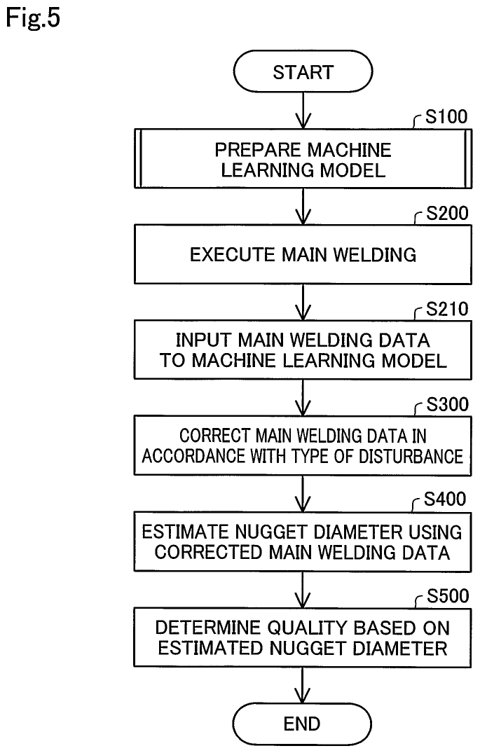

FIG. 5 is a process diagram of a resistance spot welding method in the present embodiment. In S100, a machine learning model 222 is prepared. Such as S100, the step of preparing the machine learning model 222 is referred to as a preparation step. In S100 according to the present embodiment, the machine learning model 222 is generated by executing a generation process to be described later. In the preparation step in another embodiment, the machine learning model 222 may be prepared by, for example, the controller 20 obtaining the machine learning model 222 from another computer, a recording medium, or the like.

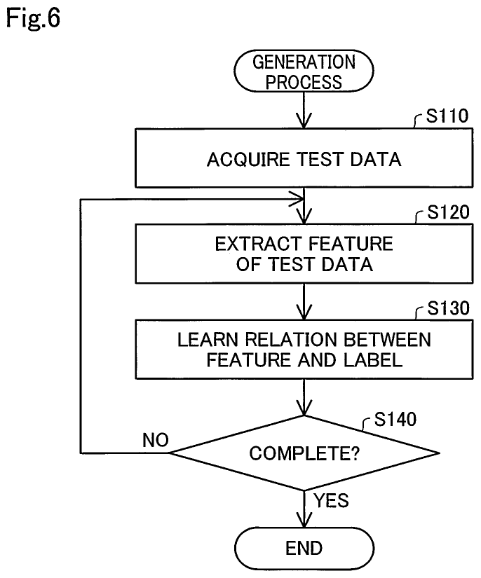

FIG. 6 is a flowchart of a generation process. In S110, the learning model generator 76 acquires test data 223. In S120 and S130, the learning model generator 76 generates the machine learning model 222 by performing supervised learning using the test data 223 as supervised data. Specifically, at first, the learning model generator 76 extracts the feature of the test data 223 in S120. Next, in S130, the learning model generator 76 executes learning the relation between the feature extracted from the test data 223 and the label associated with the test data 223. In S140, the learning model generator 76 determines whether or not the machine learning is completed. In S140, for example, when the learning is completed with respect to all the test data 223 acquired by S110, the learning model generator 76 determines that the machine learning is completed. When it is determined that the machine learning is not completed in S140, the learning model generator 76 returns the process to S120.

In S200 of FIG. 5, the main welding is performed. In S200, together with the main welding is executed by the operation control unit 71, the expansion amount is calculated by the expansion amount calculating unit 72, and the main welding data 224 is generated by the time series data generating unit 73. Next, a determination step is performed in from S210 to S500. The determination step means that a step of determining the quality of the welding state of the main welding using the main welding data 224 and the machine learning model 222.

In S210, the first step is performed. The first step is a step of implementing a first determination and determining a type of the disturbance using the main welding data 224 and the machine learning model 222. The first determination means determining whether the welding state of the main welding is defective. The determined type of the disturbance in the first step is in in the main welding in which the welding state is not determined to be defective. In S210 of the present embodiment, the determination unit 77 performs the first step by inputting the main welding data 224 to the machine learning model 222.

From S300 to S500, a second step is performed. The second step is a step of implementing a second determination using the determined type of disturbance in the first step and the main welding data 224. The second determination means determining the quality of the welding state of the main welding that is determined not defective in the first step. When the welding state of the main welding is determined to be defective in S200, the steps from S300 to S500 are omitted.

In S300, the main welding data 224 is corrected in accordance with the type of disturbances determined by S200. In S300 in the present embodiment, the correction unit 74 refers to the correction equation data 226 based on the type of disturbance determined by S200, and corrects the main welding data 224 using a correction equation corresponding to the type of the disturbance.

In S400, the nugget diameter is estimated using the main welding data 224 corrected by S300. In S400 in the present embodiment, the nugget diameter estimation unit 75 estimates the nugget diameter using the main welding data 224 corrected by S300 and the estimation equation included in the estimation equation data 225.

In S500, the quality of the welding state of main welding is determined based on the nugget diameter estimated by S400. In S500 in the present embodiment, the determination unit 77 determines the quality of the welding state of the main weld by determining whether or not the nugget diameter estimated in S400 is a predetermined threshold or more. Specifically, when the nugget diameter is equal to or greater than the threshold value, the determination unit 77 determines that the welding state of the main welding is good. Conversely, when the nugget diameter is less than the threshold value, the determination unit 77 determines that the welding state of the main welding is defective.

Incidentally, in S200, a plurality of times of the main welding may be performed. In this case, each main welding data 224 corresponding respectively to each main welding is generated. Furthermore, in this case, for example, the steps from S210 to S500 with respect to each main welding may be performed a series of main welding is completed, or the steps from S210 to S500 may be repeatedly performed for each single main welding.

According to the resistance spot welding method in the present embodiment described above comprises preparing the machine learning model 222 that learns the relation between the feature of the test data 223 and the quality of the test welding, and determining the quality of the main welding using the main welding data 224 and the machine learning model 222. The feature of the test data 223 includes a first feature relating to the gradient of the change in the expansion amount in the expansion period PE, and a second feature relating to the gradient of the change in the expansion amount in the contraction period PC. According to this embodiment, it is possible to determine the quality of the welding state of the main welding using the machine learning model 222. Furthermore, since the feature of the test data 223 includes a first feature and a second feature representing the gradient of the expansion amount change, respectively, it can accurately determine the quality of the welding state of the main welding. Specifically, for example, even when the length of the expansion period and contraction period in the test data 223 and those in the main welding data 224 are different, it can accurately determine the quality of the welding state of the main welding using the machine learning model 222.

In the present embodiment, the determination step includes a first step and a second step. In the first step, the first determination is performed, and the type of disturbance in the main welding in which the welding state is not determined to be defective in the first determination is determined. In the first step, a machine learning model 222 that has learned the relation between the feature of the test data 223 and the type of disturbance in the test welding, and the main welding data 224 are used. The first determination means determining whether or not the welding state of the main welding is defective. In the second step, the quality of the welding state of the main welding that is not determined to be defective in the first determination is determined using the type of the determined disturbance and the main welding data 224. Therefore, it is possible to suppress the determination accuracy of the quality of the welding state of the main welding is reduced due to the disturbance. Furthermore, for example, such as the test data TD2 of FIG. 2, the gradient of the expansion amount in the expansion period PE of the test data 223 including a “gap” as a disturbance is smaller than the gradient of the expansion amount in the expansion period PE of the test data 223 containing no disturbance such as the test data TD1. Furthermore, although not shown in the figure, for example, the absolute value of the gradient of the expansion amount in the contraction period PC of the test data 223 including an “edge” as disturbance is larger than the absolute value of the gradient of the expansion amount in the contraction period PC of the test data 223 including no disturbance. Thus, the gradient of the expansion amount change in the expansion period PE and contraction period PC reflects the properties of the disturbances. Therefore, as described above, since the feature used for generating the machine learning model 222 includes the first feature and the second feature, the type of the disturbance can be determined more accurately in the first step.

In the present embodiment, in the second step, the main welding data 224 is corrected in accordance with the type of disturbance, the nugget diameter in the main welding is estimated using the corrected main welding data 224, and the quality of the welding state of the main welding is determined based on the estimated nugget diameter. According to this embodiment, since estimating the nugget diameter by using the main welding data 224 corrected in accordance with the type of disturbance, the nugget diameter can be accurately estimated even when the main welding includes the disturbance. Then, based on the nugget diameter thus estimated, it is possible to determine the quality of the main welding more accurately.

In the present embodiment, the machine learning model 222 is generated by machine learning using test data 223 associated with a first label representing a test welding having a good weld state and not including a disturbance, test data 223 associated with a second label representing a type of disturbance in a test welding having a good weld state and including a disturbance, and test data 223 associated with a third label representing a test welding having a defective welding state. Therefore, the first step can be easily performed by inputting the main welding data 224 into the machine learning model 222.

In the present embodiment, the first feature includes a third feature relating to the gradient of the change in the expansion amount in the first period PE1, and a fourth feature relating to the gradient of the change in the expansion amount in the second period PE2. Therefore, in the determination step, the possibility of better determination of the quality of the welding state of the main welding is increased. In particular, in the present embodiment, the first period PE1 is a timing before the current value change timing tc, the second period PE2 is a timing after the current value change timing tc. Therefore, even when changing the size of the welding current in the middle of the expansion period PE in the main welding, it is possible to accurately determine the quality of the welding state of the main welding.

### B. Other Embodiments

(B1) In the above embodiment, the feature of the test data 223 used for generating the machine learning model 222 includes the maximum value of the expansion quantity in the expansion period PE, the minimum value of the expansion quantity in the contraction period PC, and a change amount of the expansion quantity in the contraction period PC, in addition to the first feature and the second feature. In contrast, as long as the feature of the test data 223 includes a first feature and the second feature, the feature of the test data 223 may not include the maximum value of the expansion amount in the expansion period PE, the minimum value of the expansion amount in the contraction period PC, and the change amount of the expansion amount in the contraction period PC. The feature of the test data 223 may include features other than the above.
(B2) In the above-described embodiment, in the determination step, the first determination and the second determination are executed. In contrast, in the determination step, the first determination and the second determination may not be executed. For example, in the determination step, the quality of the welding state of the main welding may be determined by simply inputting the main welding data 224 to the machine learning model 222. In this case, the machine learning model 222 may not have learned the relation between the feature of the test data 223 and the type of the disturbance in the test welding.
(B3) In the above-described embodiment, in the second determination, the main welding data 224 is corrected according to the type of disturbance, and the nugget diameter in the main welding is estimated using the corrected main welding data 224. In contrast, the nugget diameter may not be estimated using the main welding data 224 corrected. For example, by using different estimation equations depending on the type of disturbance, the nugget diameter may be estimated according to the type of disturbance.
(B4) In the above embodiment, the quality of the welding state of the main welding that is not determined to be defective in the first determination is determined based on the nugget diameter estimated by the nugget diameter estimation unit 75. In contrast, the quality of the welding state of the main welding may not be determined based on the nugget diameter. For example, by inputting the main welding data 224 corrected in accordance with the determined type of disturbance to the machine learning model 222, it may be determined that the welding state that is not determined to be defective in the first determination is good or bad.
(B5) In the above embodiment, the machine learning model 222 is generated by machine learning using the test data 223 associated with the first label, the test data 223 associated with the second label, and the test data 223 associated with the third label. In contrast, the machine learning model 222 may not be generated in this manner, and may be generated, for example, by machine learning using the test data 223 associated with the second label and the test data 223 associated with the third label. Furthermore, when the first step and the second step is not performed in the determination step, the machine learning model 222 may be generated, for example, by machine learning using the test data 223 associated with the first label and the test data 223 associated with the third label.
(B6) In the above embodiment, the first feature includes a third feature and a fourth feature. In contrast, the first feature may not include the third feature and the fourth feature.
(B7) In the above embodiment, the machine learning model 222 may have learned the relation between the feature of the test data 223 and another type of disturbance other than “gap” and “edge”.

The present disclosure is not limited to the embodiments described above and is able to be realized with various configurations without departing from the spirit thereof.

For example, technical features in the embodiments may be replaced with each other or combined together as necessary in order to solve part or the whole of the problems described previously or to achieve part or the whole of the effects described previously. When the technical features are not described as essential features in the present specification, they are able to be deleted as necessary. For example, the present disclosure may be realized with embodiments which will be described below.
(1) According to one aspect of the present disclosure, a method of resistance spot welding is provided. The method comprises: preparing a machine learning model having learned a relation between a feature of a test data and a quality of a welding state of a test welding, the test data recording a time series change of an expansion amount of a workpiece in the test welding; and determining the quality of the welding state of a main welding using a main welding data and the machine learning model, the main welding data recording a time series change of an expansion amount of the workpiece in the main welding. The feature includes a first feature and a second feature, the first feature being with respect to a gradient of a change in an expansion amount of the workpiece during an expansion period in which the workpiece expands by energization, the second feature being with respect to a gradient of a change in an expansion amount of the workpiece during a contraction period in which the workpiece contracts after the expansion period.

According to this aspect, it is possible to determine the quality of the welding state of the main welding by using a machine learning model that has learned the relation between the feature of the test data and the quality of the welding state of the test welding. the feature includes the first feature and the second feature, the first feature and the second feature being a feature relating to the gradient of the change in the expansion amount, respectively. Therefore, it can accurately determine the quality of the welding state of the main welding.
(2) According to the above aspect, in the step of preparing the machine learning model, the machine learning model having learned a relation between the feature and a type of a disturbance in the test welding may be prepared. The step of determining the quality of the welding state of the main welding may comprises: a first step of implementing a first determination to determine whether the welding state of the main welding is defective and determining a type of the disturbance in the main welding in which the welding state is not determined to be defective in the first determination, using the main welding data and the machine learning model; and a second step of implementing a second determination to determine the quality of the welding state of the main welding in which the welding state is not determined to be defective in the first determination, using the determined type of the disturbance and the main welding data. According to this aspect, in the second step, the quality of the welding state of the main welding is not determined to be defective in the first determination can be determined using the main welding data and the type of disturbance determined in the first step. Therefore, it is possible to suppress the determination accuracy of the quality of the welding state of the main welding is reduced due to the disturbance.
(3) According to the above aspect, the second determination may comprise correcting the main welding data in accordance with the type of the disturbance, estimating a nugget diameter of a nugget in the main welding using the corrected main welding data, and determining the quality of the welding state of the main welding based on the estimated nugget diameter. According to this aspect, since the nugget diameter is estimated using the main welding data corrected in accordance with the type of disturbance, the nugget diameter can be accurately estimated even when the main welding includes the disturbance. Then, based on the nugget diameter thus estimated, it is possible to determine the quality of the main welding more accurately.
(4) According to the above aspect, the machine learning model may be generated by machine learning using the test data associated with a first label, the test data associated with a second label, and the test data associated with a third label, the first label representing the test welding having a good welding state and no disturbance, the second label representing a type of the disturbance in the test welding having a good welding state and including the disturbance, and the third label representing the test welding having a defective welding state. According to this aspect, the first step can be easily performed by inputting the main welding data into the machine learning model.
(5) According to the above aspect, The first feature may include a feature relating to a gradient of a change in an expansion amount of the workpiece during a first period, and a feature relating to a gradient of a change in an expansion amount of the workpiece during a second period after the first period. According to this aspect, the possibility of being able to more accurately determine the quality of the welding state of the main welding increases.

The present disclosure is feasible in various aspects other than the method of resistance spot welding. For example, the present disclosure may be realized in aspects including a method of generating a machine learning model, a resistance spot welding apparatus, a method of controlling the resistance spot welding apparatus, a computer program for implementing the control method, and a non-temporary recording medium in which the computer program is recorded.

What is claimed is:

1. A method of resistance spot welding, comprising:
preparing a machine learning model having learned a relation between a feature of a test data and a quality of a welding state of a test welding, the test data recording a time series change in an expansion amount of a workpiece in the test welding; and
determining the quality of the welding state of a main welding using a main welding data and the machine learning model, the main welding data recording a time series change in an expansion amount of the workpiece in the main welding, wherein
the feature includes a first feature and a second feature, the first feature being with respect to a gradient of a change in an expansion amount of the workpiece during an expansion period in which the workpiece expands by energization, the second feature being with respect to a gradient of a change in an expansion amount of the workpiece during a contraction period in which the workpiece contracts after the expansion period.

2. The method of resistance spot welding according to claim 1,
wherein in the step of preparing the machine learning model, the machine learning model having learned a relation between the feature and a type of a disturbance in the test welding is prepared, and
wherein the step of determining the quality of the welding state of the main welding comprises:
a first step of implementing a first determination to determine whether the welding state of the main welding is defective and determining a type of the disturbance in the main welding in which the welding state is not determined to be defective in the first determination, using the main welding data and the machine learning model; and
a second step of implementing a second determination to determine the quality of the welding state of the main welding in which the welding state is not determined to be defective in the first determination, using the determined type of the disturbance and the main welding data.

3. The method of resistance spot welding according to claim 2,
wherein the second determination comprises correcting the main welding data in accordance with the type of the disturbance, estimating a nugget diameter of a nugget in the main welding using the corrected main welding data, and determining the quality of the welding state of the main welding based on the estimated nugget diameter.

4. The method of resistance spot welding according to claim 2,
wherein the machine learning model is generated by machine learning using the test data associated with a first label, the test data associated with a second label, and the test data associated with a third label, the first label representing the test welding having a good welding state and no disturbance, the second label representing a type of the disturbance in the test welding having a good welding state and including the disturbance, and the third label representing the test welding having a defective welding state.

5. The method of resistance spot welding according to claim 1,
wherein the first feature includes a feature relating to a gradient of a change in an expansion amount of the workpiece during a first period, and a feature relating to a gradient of a change in an expansion amount of the workpiece during a second period after the first period.
